(19) United States
(12) Patent Application Publication
(10) Pub. No.: US 2010/0110061 A1
(43) Pub. Date: May 6, 2010

(54) LOCAL AREA IMAGE DISPLAYING SYSTEM

(75) Inventors: Yu-Ming Chen, Hsinchu (TW); Yung-Kang Fan, Hsinchu (TW)

Correspondence Address: APEX JURIS, PLLC, 12733 LAKE CITY WAY NORTHEAST, SEATTLE, WA, 98125, US

(73) Assignee: MITAC TECHNOLOGY CORP., Hsinchu (TW)

(21) Appl. No.: 12/266,528

(22) Filed: Nov. 6, 2008

(51) Int. Cl. G06F 3/038

(52) U.S. Cl. 345/213

(57) ABSTRACT

A local area image displaying system is provided for a screen of a display device for controlling a displaying area of the display device. The system includes a pixel matrix, a data driving circuit, a gate driving circuit, a timing controller, and a microprocessor unit. The pixel matrix includes plural pixel units that are arranged in a matrix form to define a global displaying area. The timing controller controls the operation timings of the data driving circuit and the gate driving circuit to selectively and respectively supply a data voltage and a gate voltage to at least one selected pixel unit. The timing controller bases on a local displaying area in which displaying is to be performed to control the data lines and the gate lines covering the local displaying area to supply the voltages so as to enable only the pixel units contained in the local displaying area.

### BACKGROUND OF THE INVENTION

1. Field of the Invention

The invention relates to image display technology, and more particularly to a local area image displaying system for a display device.

2. Description of the Related Art

The main stream of the liquid crystal displays (LCD) currently available in the market is thin-film-transistor (TFT) LCD driven in an active matrix fashion. A feature of the thin film transistor is that pixels are controlled in a manner similar to a large-scale integrated circuit constituted by silicon transistor electrodes made with thin film techniques. In other words, the electrodes are formed by lining up transistors, and each pixel is directly controlled by applying point-based pulses and can be controlled in a continuous manner.

However, the currently adopted techniques for displaying with a TFT-LCD is full screen displaying, together with variation of brightness realized through a backlight module, to exhibit information to a user. Since the displaying of information on the TFT-LCD is presented in a full screen ON/OFF fashion, in case that only a local area of the full screen is needed in carrying out the operation of information displaying, the remaining portions of the screen must be simultaneously put into operation, leading to undesired consumption of power.

According to practical experiences of use, when an idle area of a screen is larger than an in-operation area, the power consumption caused by the idle area of the screen will substantially reduce the in-service time period of a battery pack, especially for a system device that is long term carried, eventually affecting convenience and portability thereof. (For example, for a regular mobile phone, in order to acquire time data, a display of the mobile phone has to turn the full screen on, but an image displayed area for showing the time data may only take only a minor fraction of the full screen.)

### SUMMARY OF THE INVENTION

In view of the above discussed problems of the known techniques, the present invention aims to provide a local area image displaying system for a screen of a display device, which allows a target image to be displayed in a selected local image displaying area of the screen of the display device. Since the display device only consumes power for the selected local image displaying area of the screen, unnecessary power consumption can be reduced.

In an embodiment of the present invention, screen signals supplied to an LCD screen are determined by controlling matrix-arranged switches for displaying operation of the LCD screen. A gate driving circuit for horizontal rows of the matrix-arranged switches supplies gate voltages to control switching-on/off of each pixel unit; and a data driving circuit for vertical columns of the matrix-arranged switches supplies data voltages to provide a suitable voltage signal to each pixel unit.

A timing controller and a microprocessor unit connected to the timing controller together control the displaying operation of the LCD screen. The timing controller generates a data driving circuit control signal and a gate control signal. The data driving circuit control signal controls the operation timing of the data driving circuit. The gate control signal controls the operation timing of the gate driving circuit.

The data driving circuit supplies the data voltages through data lines to selected ones of the pixel units. The gate driving circuit supplies gate voltages through gate lines to the selected ones of the pixel unit. The pixel units are arranged in a pixel matrix and the pixel units that are arranged in a pixel matrix define a global displaying area.

Based on the local displaying area in which a target image is to be displayed on the global displaying area, the timing controller sends the control signals to the data lines of the data driving circuit and the gate lines of the gate driving circuit that are covered by the local displaying area in order to enable the pixel units covered by the local displaying area, whereby the target image is displayed on the selected local displaying area.

With the technical solution provided by the present invention, the timing controller may function to supply desired control signals to the data driving circuit and the gate driving circuit according to the desired local displaying area so that data voltages and gate voltages are only supplied to the data lines and gate lines covered by the local displaying area. Thus, the present invention provides a displaying method that exhibits only an in-operation area and turns off signals associated with non-operated displaying areas of the LCD screen. In this way, power utilization efficiency can be enhanced and in-service time period of a battery pack is extended.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein below for illustration only, and thus is not limitative of the present invention, and wherein:

FIG. 1 shows a system block diagram of a local area image displaying system constructed in accordance with the present invention for a screen of display device;

FIG. 2 shows a schematic view of a driving system of the display device illustrated in the embodiment of FIG. 1;

FIG. 3 shows a schematic view of a pixel unit of the embodiment illustrated in FIG. 2;

FIG. 4 shows a schematic view illustrating a global displaying area of the display device;

FIG. 5 shows a schematic view illustrating a local displaying area of the display device; and

FIG. 6 shows a schematic view illustrating another local displaying area of the display device.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description refers to the same or the like parts.

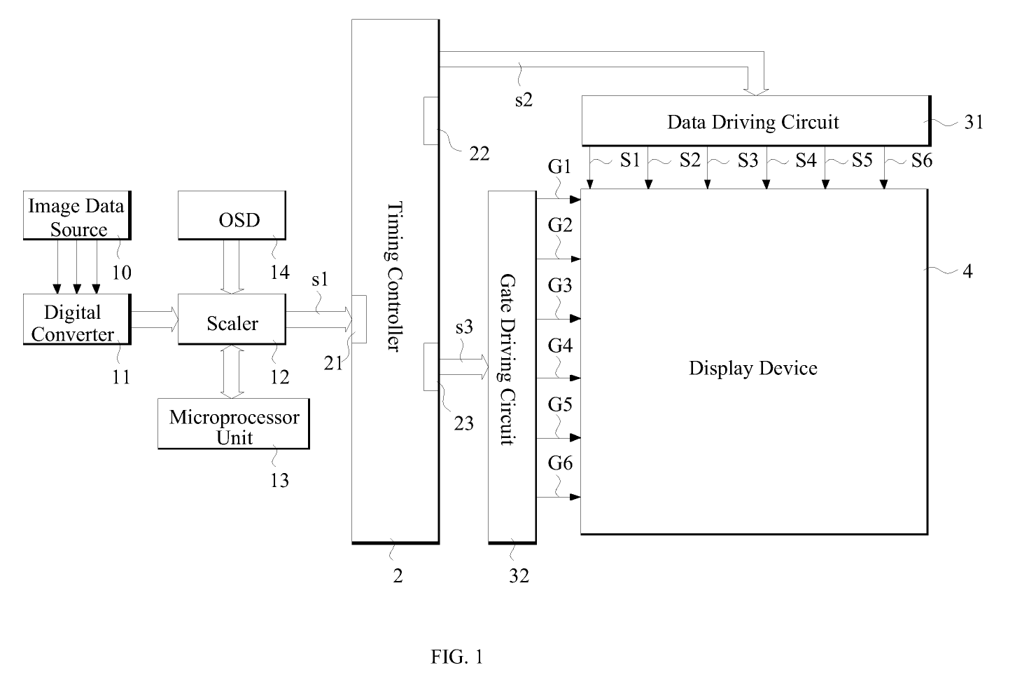

With reference to FIG. 1, which shows a system block diagram of a local area image displaying system constructed in accordance with the present invention for a screen of a display device, an image data source 10 provides a RGB analog signal that is comprised of red, green, and blue component to an analog to digital converter (ADC) 11 for conversion of the analog signal into a digital signal, which is then applied to a scaler 12. The scaler 12 functions to perform adjustment in accordance with image-related parameters regarding to image resolution or shape and size contained in the digital signal provided by the analog to digital converter 11.

The scaler 12 is connected to a microprocessor unit 13 and an on-screen display (OSD) adjuster 14. The OSD adjuster 14 allows for fine adjustment of displaying-related parameters, such as brightness and contrast of screen displaying and horizontal and vertical positioning, of the image data that have been subjected to adjustment realized through the scaler 12. Further, the OSD adjuster 14 can be embedded or optional according to the numbers of language and font that the system can support.

During the processing of image data, the microprocessor unit 13 carries out reception and conversion of the image signal and interlaced scanning. In addition, it also helps the OSD adjuster 14 in appearance adjustment and font conversion. The scaler 12 transmits the adjusted and integrated image data as an image data signal s1 to a timing controller 2.

The timing controller 2 comprises an image signal source connection portion 21, a data driving circuit connection port 22, and a gate driving circuit connection port 23. The image data signal s1 provided by the scaler 12 is fed to the timing controller 2 through the image signal source connection port 21.

The timing controller 2 uses the data driving circuit connection port 22 and the gate driving circuit connection port 23 to respectively connect with the data driving circuit 31 and the gate driving circuit 32. The timing controller 2 generates a data driving circuit control signal s2 and a gate control signal s3 that respectively control the operation timings of the data driving circuit 31 and the gate driving circuit 32.

A display device 4 is connected to the data driving circuit 31 and the gate driving circuit 32, whereby the data driving circuit 31 and the gate driving circuit 32 supply data voltages and gate voltages to the display device 4 for displaying an image thereon.

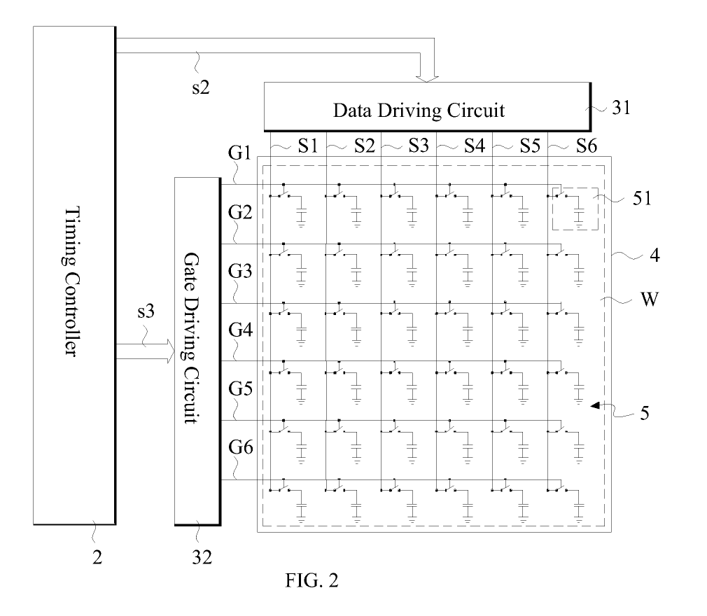

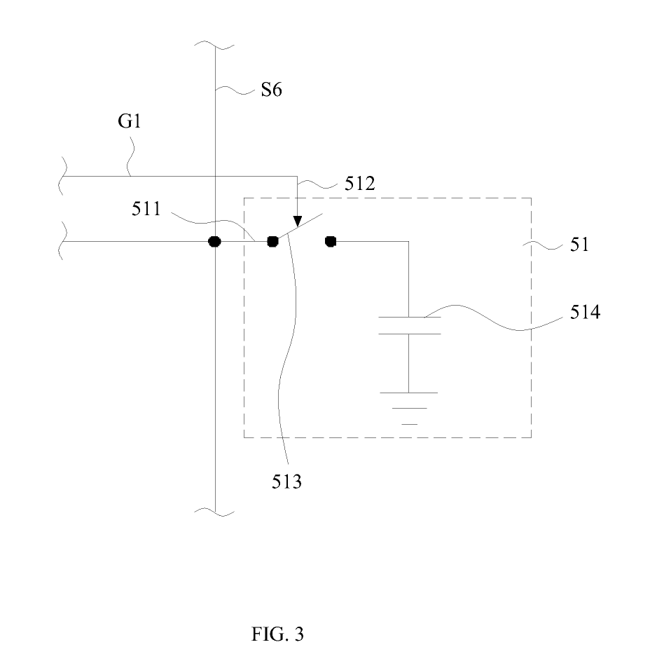

As shown in FIG. 2, which is a schematic view of a driving system of the display device illustrated in the embodiment of FIG. 1, the display device 4 comprises a pixel matrix 5, which is formed by arranged a plurality of pixel units 51 in a matrix. The pixel matrix 5 defines a global displaying area W on the display device 4. Each pixel unit 51 has a data terminal 511, a gate terminal 512, a switch unit 513, and a capacitor 514 (see FIG. 3).

The data driving circuit 31 comprises a plurality of data lines S1-S6. These data lines S1-S6 are respectively connected to the data terminals 511 of the pixel units 51. The data driving circuit 31 selectively supplies a data voltage to the data line S1-S6 of at least one selected pixel unit. And also, the image data signal s1 and the data driving circuit control signal s2 generated by the timing controller 2 are transmitted with the data voltages generated by the data driving circuit 31 to the data lines S1-S6 of the selected pixel units 51 of the pixel matrix 5.

The gate driving circuit 32 comprises a plurality of gate lines G1-G6. These gate lines G1-G6 are respectively connected to the gate terminals 512 of the pixel units 51. The gate driving circuit 32 selectively supplies a gate voltage to the gate lines G1-G6 of at least one selected pixel unit. And also, the gate control signal s3 generated by the timing controller 2 is transmitted with the gate voltages generated by the gate driving circuit 32 to the gate lines G1-G6 of the selected pixel units 51 of the pixel matrix 5.

In FIG. 3, the pixel unit 51 uses the data terminal 511 and the gate terminal 512 to respectively receive the data voltage supplied by the data driving circuit 31 through the data line S1-S6 and the gate voltage supplied by the gate driving circuit 32 through the gate lines G1-G6. The switch unit 513 is a switching circuit that is comprised of for example a transistor based switching unit, such as a metal-oxide-semiconductor field effect transistor (MOS-FET) or other power transistor.

To display the image of the image data signal s1 with the pixel units 51, the gate voltage supplied by the gate driving circuit 32 controls the switch units 513 of the pixel units 51 and the data voltage supplied by the data driving circuit 31 conveys primary color signals of red, blue, and green fed from the image data source 10.

The gate driving circuit 32 operates to control the supply of a gate voltage to each gate line G1-G6 of the pixel matrix 5. When an image is subjected to a one-time row-by-row scanning operation, the gate driving circuit 32 supplies the gate voltage to the gate terminals 512 of the pixel units 51 to close all the switch units 513 comprised in a row to allow the data driving circuit 31 to supply the data voltages that contain image signals to the data terminals 511 of the pixel units 51.

The data driving circuit 31 operates to control the supply of a data voltage through each individual data line S1-S6 to the data terminals 511 of the pixel units 51 of the pixel matrix 5. When the gate driving circuit 32 close or open all the switch units 513 comprised in a row, the data driving circuit 31 supplies the data voltages to a whole row of the pixel matrix 5 in accordance with the image data signal s1 and the data driving circuit control signal s2 generated by the timing controller 2 to exhibit the pixels that form a combined and complete image.

Further, to display various colors for a complete image in the display device 4, it is obtained through the color levels of the sub-pixel of the primary color signals of red, blue, and green from the image data source 10. Color level control is performed in accordance with the level of gate voltage supplied from the gate driving circuit 32.

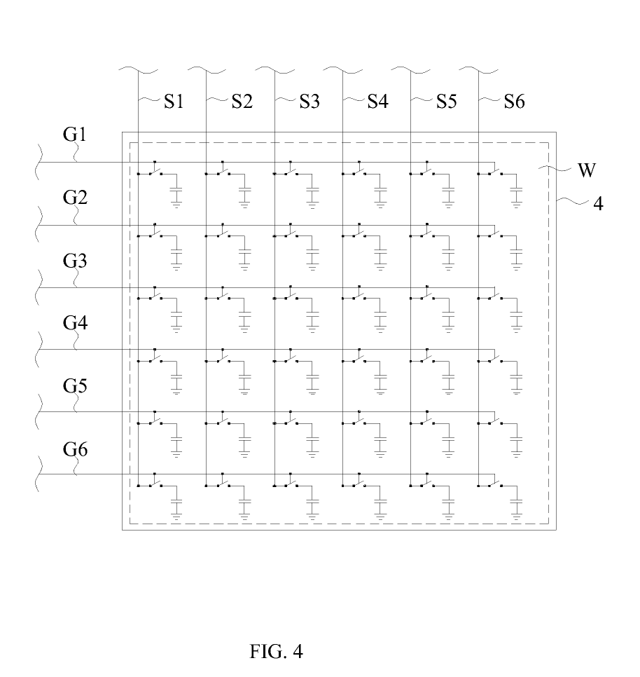

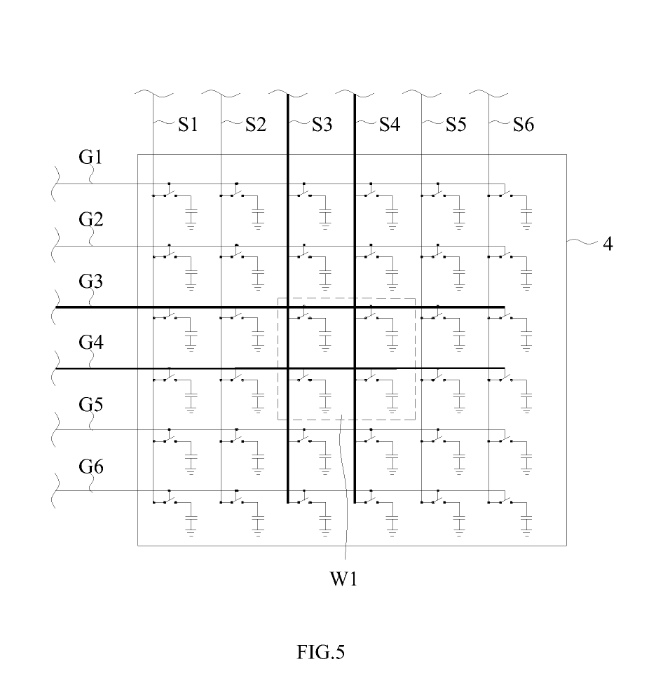

For the present invention that realizes displaying image in a local portion of a screen, the timing controller 2 generates, in response to a local displaying area W1 (see FIG. 5), which comprises a fraction of the global displaying area W (see FIG. 4), for displaying a target image therein, a data driving circuit control signal s2 and a gate control signal s3 associated with the said local displaying area W1. The data driving circuit 31 bases on the data driving circuit control signal s2 associated with the local displaying area W1 to supply data voltages to the data lines S3, S4 of the pixel units 51 that are covered by the local displaying area W1 and also, the gate driving circuit 32 bases on the gate control signal s3 associated with the local displaying area W1 to supply gate voltages to the gate lines G3, G4 of the pixel units 51 covered by the local displaying area W1, whereby the pixel units 51 contained in the local displaying area W1 can be enabled to display the target image in the selected local displaying area W1.

For displaying the target image in the local displaying area W1, the embodiment discussed above employs selective driving of the data lines S3, S4 and gate lines G3, G4 associated with the local displaying area W1. Alternatively, it is also feasible to simultaneously drive all the data lines S1-S6, but only drive the gates lines G3, G4 associated with the local displaying area W1. This also allows the pixel units 51 contained in the local displaying area W1 to be enabled for displaying the target image in the selected local displaying area W1. It is apparent that, alternatively, only the data lines S3, S4 associated with the local displaying area W1 are driven, but all the gate lines G1-G6 are simultaneously driven for enabling only the pixel units 51 contained in the local displaying area W1 to display the target image in the selected local displaying area W1.

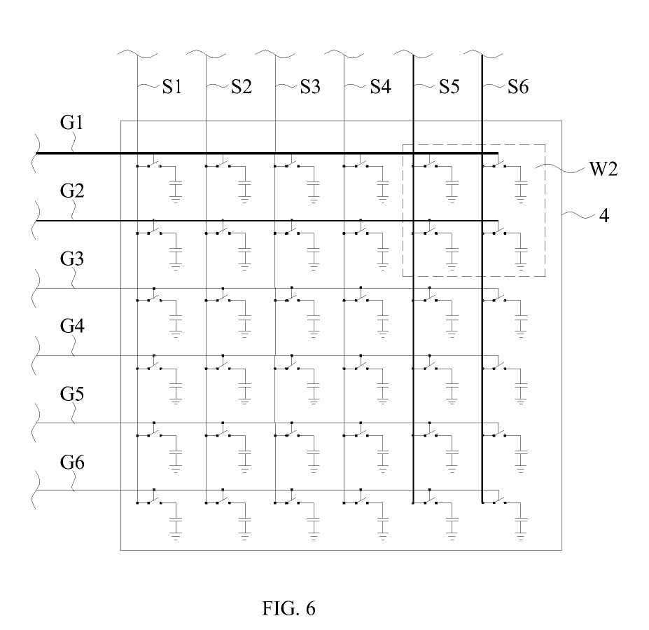

Similarly, when an attempt is made to display a target image in a different local displaying area W2 (see FIG. 6) that comprises a fraction of the global displaying area W, the data driving circuit 31 drives the data lines S5, S6 associated with the pixel units 51 covered by the local displaying area W2 and the gate driving circuit 32 drives the gate lines G1, G2 associated with the pixel units 51 covered by the local displaying area W2, whereby the pixel units 51 contained in the local displaying area W2 can be properly enabled to display the target image in the selected local displaying area W2.

Additional advantages and modifications will readily occur to those proficient in the relevant fields. The invention in its broader aspects is therefore not limited to the specific details and representative embodiments shown and described herein. Accordingly, various modifications may be made without departing from the spirit or scope of the general inventive concept as defined by the appended claims and their equivalents.

What is claimed is:

1. A local area image displaying system for a screen of a display device, which controls a displaying area of the display device, the system comprises:
a pixel matrix, which comprises a plurality of pixel units that are arranged in a matrix form in the pixel matrix to define a global displaying area, each pixel unit having a data terminal and a gate terminal;
a data driving circuit, which comprises a plurality of data lines that are respectively connected to the data terminals of the corresponding pixel units and which selectively supplies a data voltage to the data line of at least one selected pixel unit;
a gate driving circuit, which comprises a plurality of gate lines that are respectively connected to the gate terminals of the corresponding pixel units and which selectively supplies a gate voltage to the gate line of at least one selected pixel unit;
a timing controller, which controls operation timings of the data driving circuit and the gate driving circuit, the timing controlling comprising:
an image signal source connection portion, which receives an image data signal;
a data driving circuit connection port, which is connected to the data driving circuit for transmitting a data driving circuit control signal, together with the image data signal, through the data driving circuit to the data line of the selected pixel unit of the pixel matrix; and
a gate driving circuit connection port, which is connected to the gate driving circuit for transmitting a gate control signal through the gate driving circuit to the gate line of the selected pixel unit of the pixel matrix; and
a microprocessor unit, which is connected to the timing controller;
wherein, based on a local displaying area of the global displaying area in which a target image is to be displayed, the timing controller controls the data driving circuit to drive the data lines covering the local displaying area and also controls the gate driving circuit to drive the gate lines covering the local displaying area to thereby enable the pixel units contained in the local displaying area for displaying the target image in the local displaying area.

2. The local area image displaying system as claimed in claim 1, wherein the timing controller is connected to a scaler for performing adjustment of an image parameter of the image data signal.

3. The local area image displaying system as claimed in claim 2, wherein the scaler is connected to an on-screen display adjuster for performing adjustment of a displaying parameter of the display device.

4. A local area image displaying system for a screen of a display device, which controls a displaying area of the display device, the system comprises:
a pixel matrix, which comprises a plurality of pixel units that are arranged in a matrix form in the pixel matrix to define a global displaying area, each pixel unit having a data terminal and a gate terminal;
a data driving circuit, which comprises a plurality of data lines that are respectively connected to the data terminals of the corresponding pixel units and which supplies a data voltage to the data line of each pixel unit;
a gate driving circuit, which comprises a plurality of gate lines that are respectively connected to the gate terminals of the corresponding pixel units and which selectively supplies a gate voltage to the gate line of at least one selected pixel unit;
a timing controller, which controls operation timings of the data driving circuit and the gate driving circuit, the timing controlling comprising:
an image signal source connection portion, which receives an image data signal;
a data driving circuit connection port, which is connected to the data driving circuit for transmitting a data driving circuit control signal, together with the image data signal, through the data driving circuit to the data line of the selected pixel unit of the pixel matrix; and
a gate driving circuit connection port, which is connected to the gate driving circuit for transmitting a gate control signal through the gate driving circuit to the gate line of the selected pixel unit of the pixel matrix; and
a microprocessor unit, which is connected to the timing controller;
wherein, based on a local displaying area of the global displaying area in which a target image is to be displayed, the timing controller controls the data driving circuit to drive the data lines covering the global displaying area and also controls the gate driving circuit to drive the gate lines covering the local displaying area to thereby enable the pixel units contained in the local displaying area for displaying the target image in the local displaying area.

5. The local area image displaying system as claimed in claim 4, wherein the timing controller is connected to a scaler for performing adjustment of an image parameter of the image data signal.

6. The local area image displaying system as claimed in claim 5, wherein the scaler is connected to an on-screen display adjuster for performing adjustment of a displaying parameter of the display device.

7. A local area image displaying system for a screen of a display device, which controls a displaying area of the display device, the system comprises:
a pixel matrix, which comprises a plurality of pixel units that are arranged in a matrix form in the pixel matrix to define a global displaying area, each pixel unit having a data terminal and a gate terminal;
a data driving circuit, which comprises a plurality of data lines that are respectively connected to the data terminals of the corresponding pixel units and which selectively supplies a data voltage to the data line of at least one selected pixel unit;
a gate driving circuit, which comprises a plurality of gate lines that are respectively connected to the gate terminals of the corresponding pixel units and which supplies a gate voltage to the gate line of each pixel unit;
a timing controller, which controls operation timings of the data driving circuit and the gate driving circuit, the timing controlling comprising:
an image signal source connection portion, which receives an image data signal;
a data driving circuit connection port, which is connected to the data driving circuit for transmitting a data driving circuit control signal, together with the image data signal, through the data driving circuit to the data line of the selected pixel unit of the pixel matrix; and
a gate driving circuit connection port, which is connected to the gate driving circuit for transmitting a gate control signal through the gate driving circuit to the gate line of the selected pixel unit of the pixel matrix; and
a microprocessor unit, which is connected to the timing controller;
wherein, based on a local displaying area of the global displaying area in which a target image is to be displayed, the timing controller controls the data driving circuit to drive the data lines covering the local displaying area and the also controls the gate driving circuit to drive the gate lines covering the global displaying area to thereby enable the pixel units contained in the local displaying area for displaying the target image in the local displaying area.

8. The local area image displaying system as claimed in claim 7, wherein the timing controller is connected to a scaler for performing adjustment of an image parameter of the image data signal.

9. The local area image displaying system as claimed in claim 8, wherein the scaler is connected to an on-screen display adjuster for performing adjustment of a displaying parameter of the display device.
